(19) United States
(12) Patent Application Publication
(10) Pub. No.: US 2004/0040129 A1
(43) Pub. Date: Mar. 4, 2004

(54) Memorial

(76) Inventor: George B. Ogle II, Capistrano Beach, CA (US)

Correspondence Address: CHRISTIE, PARKER & HALE, LLP, P.O. BOX 7068, PASADENA, CA, 91109-7068, US

(21) Appl. No.: 10/430,638

(22) Filed: May 6, 2003

Related U.S. Application Data
(63) Continuation-in-part of application No. 10/230,725, filed on Aug. 29, 2002.

(51) Int. Cl. A61G 17/00

(52) U.S. Cl. 27/1

(57) ABSTRACT

For a person or a pet includes a body in the shape of a protective angel on a support having an outwardly extending shelf adjacent the angel, and on which a representation of the person or pet may rest. The arms and wings of the angel are disposed to symbolize loving concern for the deceased. In a preferred form of the invention, the body also includes an outwardly opening cavity in the body to receive cremated remains of the person or pet, and a cover secured over the cavity confines the cremated remains within the body. Another preferred embodiment includes a connection for anchoring the memorial to the ground.

### CROSS-REFERENCE TO RELATED APPLICATION

This application is a continuation-in-part of U.S. patent application Ser. No. 10/230,725, filed Aug. 29, 2002.

### FIELD OF THE INVENTION

This invention relates to memorials for deceased people on pets.

### BACKGROUND OF THE INVENTION

Someone who loses a loved one, such as a child, parent, or close friend, often needs to memorialize the strong emotional bond resulting from love or friendship. In a similar way, owners and pets usually have a strong emotional bond between them, and when an owner loses a pet, the owner often needs a fitting way to memorialize that loss, such as by formally burying the pet in a pet cemetery, or by suitable treatment of ashes produced by cremation of the pet remains. For example, U.S. Pat. No. 6,023,882 discloses a decorative body in the general form of the deceased pet, and is constructed to hold pet ashes in a sealed chamber.

Although previous memorials, including urns for holding ashes, do commemorate a deceased person or pet, the effect is often not sufficient for those who wish to express more clearly the love and devotion that existed. This invention provides a memorial which more nearly meets that need.

### SUMMARY OF THE INVENTION

This invention provides a memorial which includes a body in the shape of a protective angel on a support having an outwardly extending shelf adjacent the angel, and on which a representation, such as a photograph or replica of the person or pet may rest. Preferably, the face of the angel shows loving concern, and the angel leans slightly over the shelf to present a sheltering and caring mien. In another preferred form, the angel looks down at the shelf which can hold a representation or replica of the deceased person or pet, and has outstretched wings to increase the expression of care and sheltering. Moreover, an outstretched arm from the angel further connotes loving concern. Preferably, the body includes a portion with an exterior surface shaped to replicate a structure of stones to impart an aura of durability. A recess in an exterior part of the body is shaped to receive a label with information relative to the person or pet.

In a presently preferred form of the invention, the body includes a connection for anchoring the memorial to the ground. In its simplest form, the connection is a downwardly extending stake which can be inserted in to the ground. In another form, the stake makes a snug fit in a socket embedded in the ground. Alternatively, the connection includes a downwardly opening socket which makes a snug fit over the upper end of an upwardly extending stake embedded in the ground.

In another preferred form of the invention, the memorial serves as an urn for storing the ashes (cremated remains) of a deceased person or pet. To this end, an outwardly opening cavity in the body receives the ashes, and a cover secured over the cavity confines the ashes within the body. Preferably, the cavity opens out of the bottom of the body, and the cover is secured to one edge of the cavity by a hinge. In one form, a magnetic closure holds the cover in a closed position over the cavity. In another embodiment, a mechanical latch releasably secures the cover in a closed position over the cavity. A gasket is disposed between the body and cover to seal the cavity when the cover is in the closed position. The body adjacent the unhinged portion of the cover has a recess to permit the edge of the cover to be grasped and pulled open against the force of the magnetic closure, or to facilitate the release of the mechanical latch. In one form, the mechanical latch has a slidable bolt which can be moved between a locked and an unlocked position for the cover. Opening of the cover is also facilitated by providing a notch in the free edge of the cover adjacent the recess in the bottom of the body. The cover and surrounding portion of the bottom of the body present a flat, smooth surface so the urn can be easily placed in a stable position.

These and other aspects of the invention will be more fully understood from the following detailed description, taken in conjunction with the accompanying drawings.

### BRIEF DESCRIPTION OF THE DRAWINGS

FIG. 1 is a front elevation of one embodiment of the memorial the form of an urn;

FIG. 2 is a bottom view of the urn;

FIG. 3 is a view taken on staggered line 3-3 of FIG. 2;

FIG. 4 is an enlarged view, partly broken away, taken in the area of the dotted circle A of FIG. 3;

FIG. 5 is a fragmentary view of the bottom of the urn showing an alternate latch for the cover; and

FIG. 6 is a view taken on line 6-6 of FIG. 5.

FIG. 7 is a front elevation of embodiment of this invention in which the memorial includes a downwardly extending stake;

FIG. 8 is a bottom view of the memorial shown in FIG. 7;

FIG. 9 is a vertical or cross-sectional view of the memorial shown in FIGS. 7 and 8 showing the stake fitted into a socket embedded in the ground;

FIG. 10 is a view similar to that of FIG. 9 showing the memorial with a downwardly opening socket to receive the upper end of a stake embedded in a supporting surface; and

FIG. 11 is a view similar to that of FIG. 10 showing the memorial with a downwardly opening socket fitted over the upper end of a stake, the lower end of which makes a snug fit in an upwardly opening socket embedded in a supporting surface.

### DETAILED DESCRIPTION OF THE INVENTION

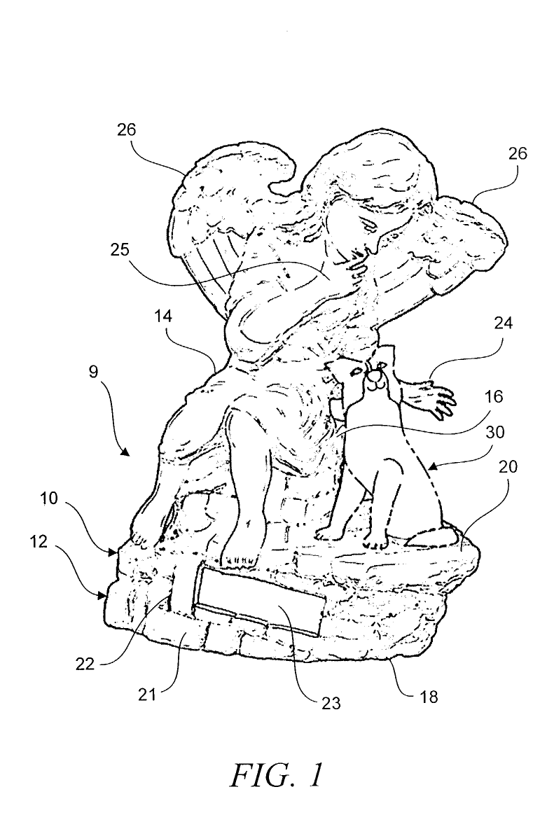

Referring to FIG. 1, a memorial 9, which also serves as an urn 10, includes a molded body 12 in the shape of an angel 14 sitting on a pedestal 16 formed integrally within the top of a base 18 having an outwardly extending flat shelf 20. The pedestal, base and platform are molded so the exterior surfaces of those elements resemble stones 21 set with mortar 22.

A recessed rectangular panel 23 in the front face of the base receives a label (not shown) with appropriate indicia. The recessed rectangular panel 23, which is about 3 mm deep, permits the label to be mounted so that its exterior surface does not project beyond that of the base, thus protecting the label from accidental abrasion.

In the embodiment shown in FIG. 1, the angel leans slightly over the base, and gazes in the direction of the base. The left hand and forearm 24 of the angel extend outwardly over the rear portion of the base, and the right hand 25 of the angel is adjacent the chin of the angel.

A pair of wings 26 molded integrally with the back of the angel extend outwardly on each side of the angel and open toward the platform 20, which is adapted to hold a representation on replica 30 of the deceased person or pet (shown only in phantom line). Thus, the effect of the angel sitting on the pedestal presents a protective pose and reverential contemplation of the space adapted to receive the replica of the person or pet.

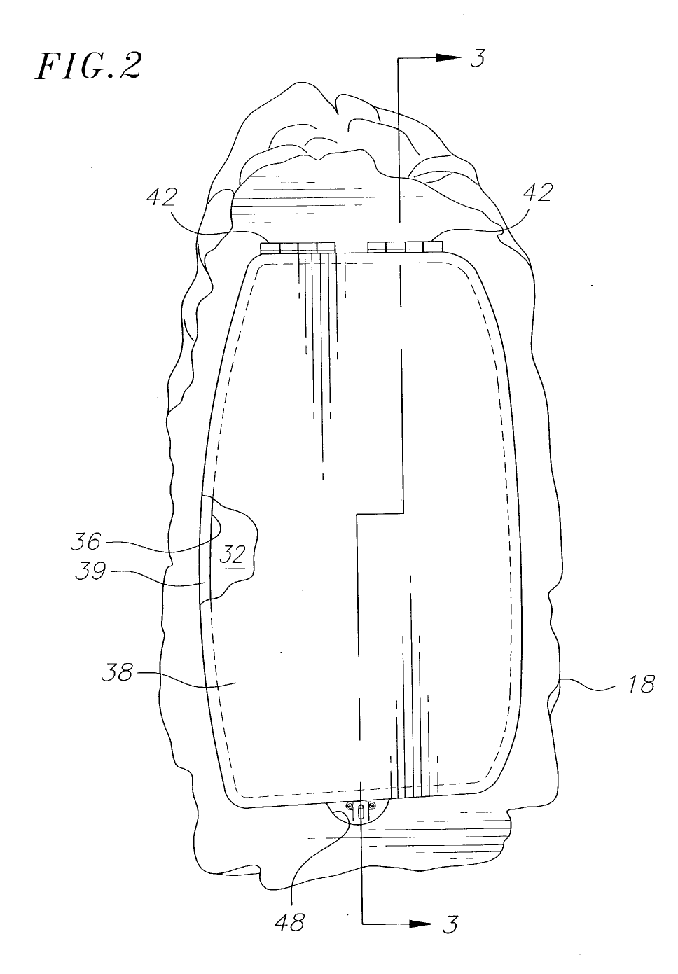

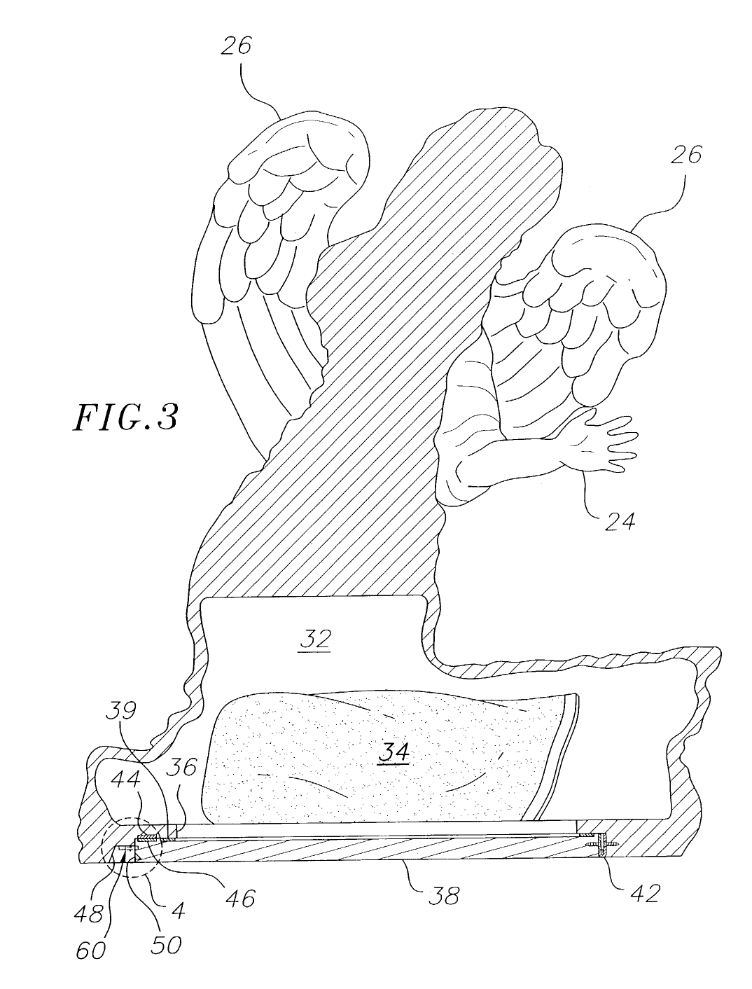

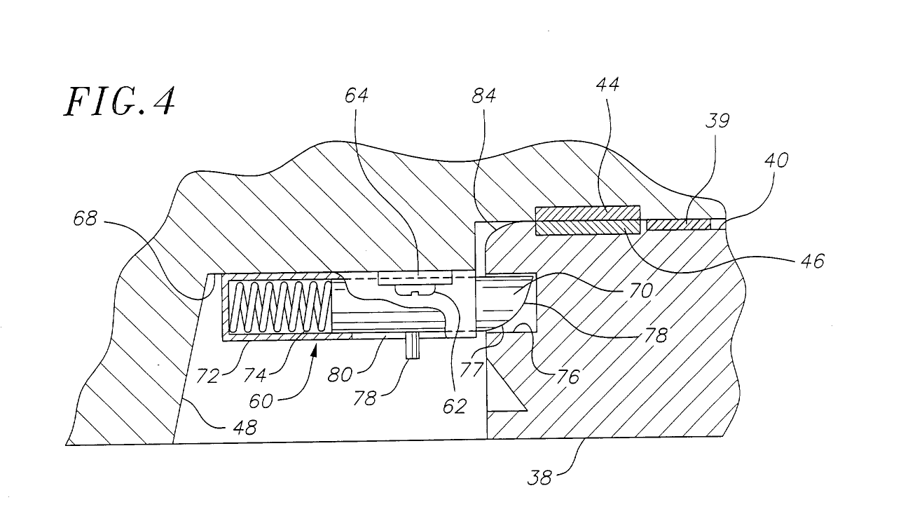

As shown best in FIGS. 2 and 3, the bottom of the body includes a downwardly opening cavity 32 adapted to hold a container 34 of ashes of the cremated remains of a deceased person or pet, or both of them. Preferably, the upper portion of the angel is solid, rather than hollow, as shown in FIG. 3, to provide greater strength for the urn. The container 34 can be any suitable device, such as a well-known Ziploc plastic bag. As shown in FIG. 2, the cavity 32 is of an elongated, generally rectangular shape, and includes an inwardly extending ledge 36 around the periphery of the opening of the cavity. A rectangular cover 38 is shaped to make a close fit within cavity 32 and rest on ledge 36. As shown in FIGS. 3 and 4, a gasket 39 in an upwardly opening recess 40 around the top surface of the cover makes a hermetic seal between the cover and the body ledge. A pair of hinges 42 secure one end of the cover to an adjacent end of the cavity.

A first magnet 44 embedded in the shelf 36 at the end of the cavity remote from the hinges mates with a second magnet 46 embedded in the upper surface of the end of the cover remote from the hinges, and holds the cover in the closed position shown in FIG. 3.

A downwardly opening indentation 48 in the lower surface of the urn body, and adjacent the free end of the cover, facilitates opening the cover against the force of the magnets. Opening the cover is further facilitated by an outwardly opening notch 50 in the free edge of the cover remote from the hinges. The indentation 48 is sufficiently large to permit one to insert a finger into that space, and engage notch 50 so that the cover can be pulled and pivoted about the hinges in a counterclockwise direction (as viewed in FIG. 3) to open the bottom of the urn so that the container with the ashes of the cremated remains of a person or pet can be inserted into the cavity 32. Preferably, the cavity is sufficiently large to hold both the cremated remains of a pet and the owner of the pet. Thereafter the cover is moved to the closed position in FIG. 3, and held in that position by the magnets. More than one set of magnets can be used at the interface between the ledge 36 and cover 38 to provide additional force for holding the cover in the closed position.

If the weight of the cremated remains stored in the cavity is too large to be reliably held by magnets, a mechanical latch 60 (FIGS. 3 and 4) is secured by screws 62 through ears 64 on opposite sides of the latch to hold the latch against the upper surface 68 of the indentation 48. The latch includes a slidable bolt 70 in a latch cylinder 72. A compression spring 74 in the cylinder urges the latch to slide to the right (as viewed in FIG. 4) so the right end of the bolt fits snugly in a cylindrical bore 76 in the free edge of the cover. A downwardly extending pin 78 is threaded at its upper end into the lower portion of the bolt, and is adapted to travel in a longitudinal slot 80 in the cylinder, so the pin 78 can be moved to the left (as viewed in FIG. 4) to withdraw the bolt from bore 76, and permit the cover to be pulled away from the cavity. The right (as viewed in FIG. 3) end of the bolt is curved to present a downwardly facing convex section 77, which merges with an upwardly and outwardly sloping segment 78, to engage a upwardly convex curved surface 84 at the upper edge of the free end of the cover so that closing and locking the cover in the closed position shown in FIG. 3 is easily done by pivoting the cover about the hinges in a clockwise direction (as viewed in FIG. 4) so that the curved surface 84 on the cover engages the convex section 77 and the sloping segment 78 on the right end of the bolt to force the bolt to the left so the cover can move to the closed position shown in FIG. 3. Compression spring 74 snaps the bolt into the bore 76 so the cover is locked in the closed position.

The memorial 9 can be made of any suitable material used for casting statues. However, I presently prefer to use unsaturated polyester resin pottery plaster, which simulates the appearance of marble. Any suitable pigment can be mixed with the casting material to give the memorial any desired color.

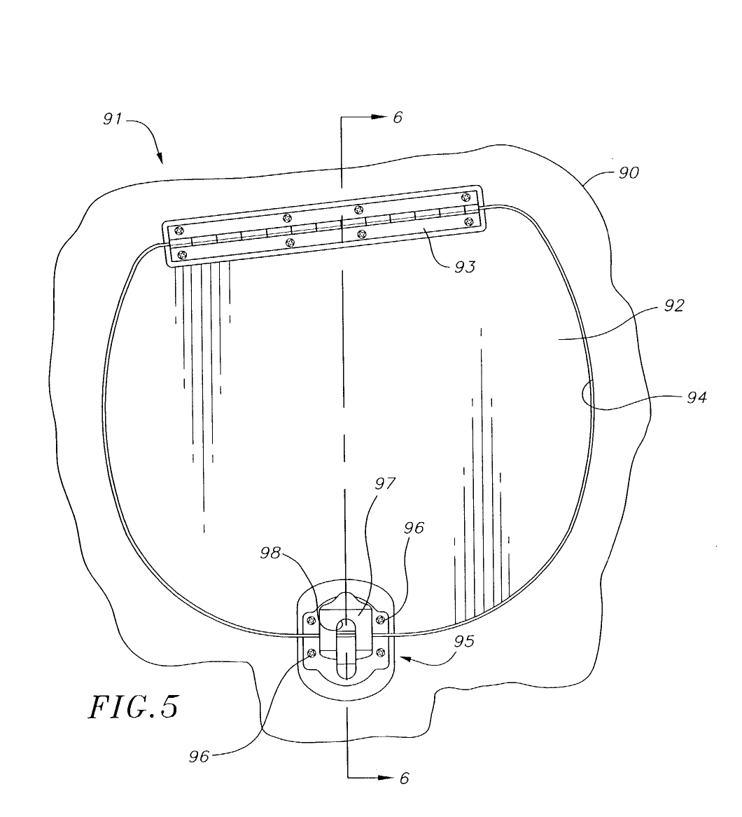

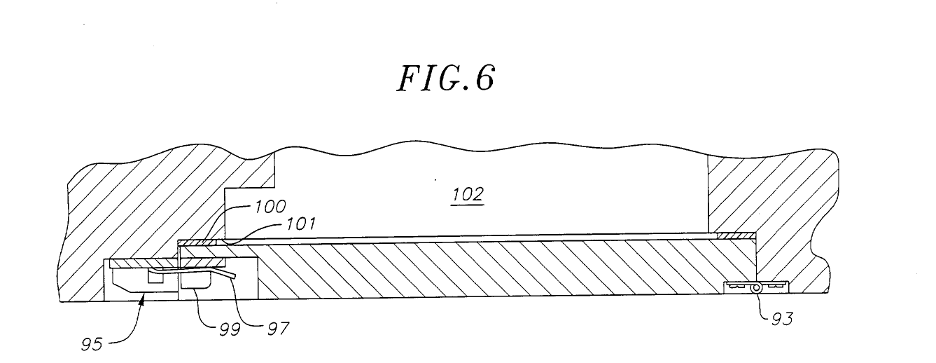

Referring to FIGS. 5 and 6, which show the bottom of a base 90 of an alternate urn 91 of this invention, a cover 92 is secured at one edge by a hinge 93 to the bottom of the base to make a snug fit over an opening 94 in the base. A conventional two-piece latch 95 is secured by screws 96 to the base and cover. The piece of the latch secured to the base includes an elongated tongue 97 with a central opening 98, which makes a snug fit over a downwardly extending latch post 99 on the piece of the latch secured to the lid. The upper surface of the perimeter of the lid (FIG. 6) makes a snug fit against a gasket 100 on a downwardly facing ledge 101 around a cavity 102 opening out of the bottom of the base. The gasket extends around the perimeter of the lid to seal the cavity from the elements. To release the cover from the closed position shown in FIG. 1, the tongue 97 is pulled downwardly (as viewed in FIG. 6) so the tongue pivots in a clockwise direction about the anchor piece secured to the base. Once the tongue clears the retaining pin 99, the lid is free to swing to the open position. The lid is moved into and secured in the closed position by reversing the opening procedure just described.

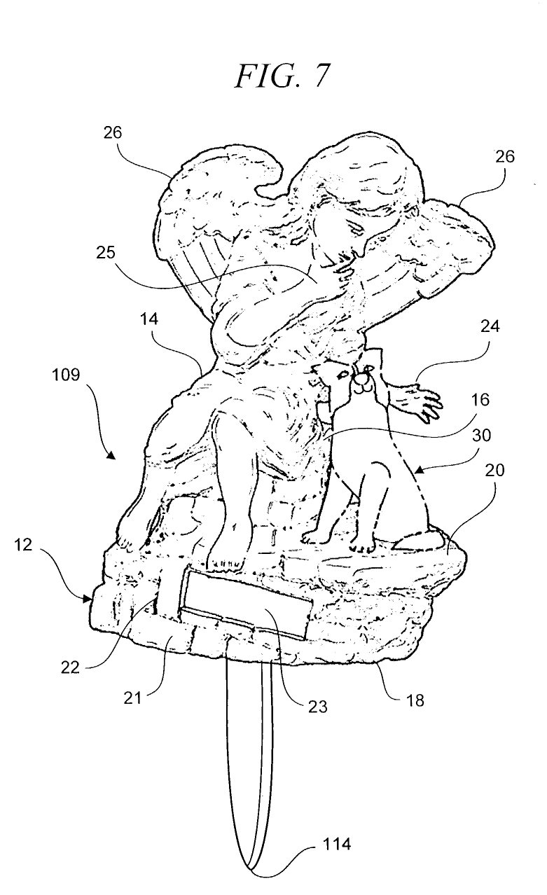

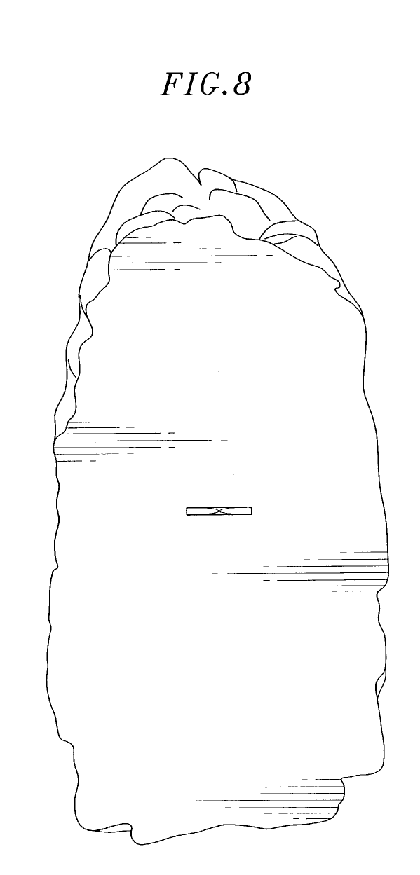

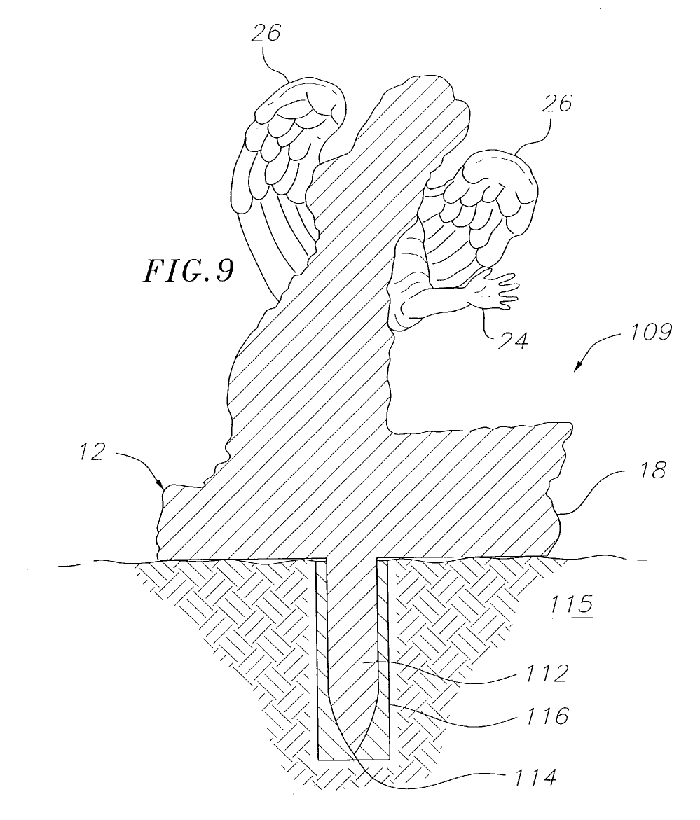

FIGS. 7-9 show an alternate embodiment of a memorial 109, which is similar to that described with respect to FIGS. 1-6. The same reference numbers are used to identify the corresponding elements of the two embodiments. The principal difference between the two embodiments is that the embodiment of FIGS. 7-9 does not have a cavity for receiving ashes. Instead, the body 12 is solid, as shown in FIG. 9, and includes a downwardly extending stake 112 in the shape of an elongated rectangular blade having a point 114 at its lower end. The upper end of the stake is formed integrally with the base 18 of the memorial. The stake 112 can be inserted into soft ground 115 to anchor the memorial in a desired location.

If the ground or other surface on which the memorial is to be placed makes it inpractical to insert the stake, an upwardly opening socket 116 is embedded in the ground or other surface 118 to receive the stake, which makes a snug fit within the socket.

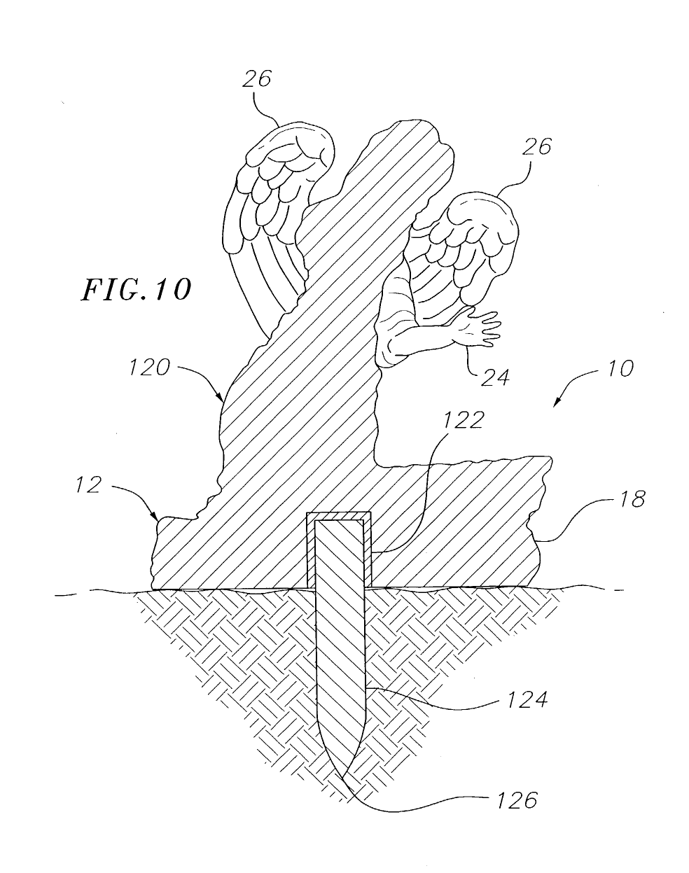

A memorial 120 shown in FIG. 10 is identical with that of FIGS. 7-9, except that a downwardly opening socket 122 is embedded in the base 18 of the body 12 to receive the upper end of a stake 124, which is in the shape of a blade having a point 126. The stake is driven into the ground, and thereafter the memorial is set on the projecting upper end of the stake, which makes a snug fit in the downwardly opening socket 122, which preferably is made of metal or some other suitable material more durable than that of the body.

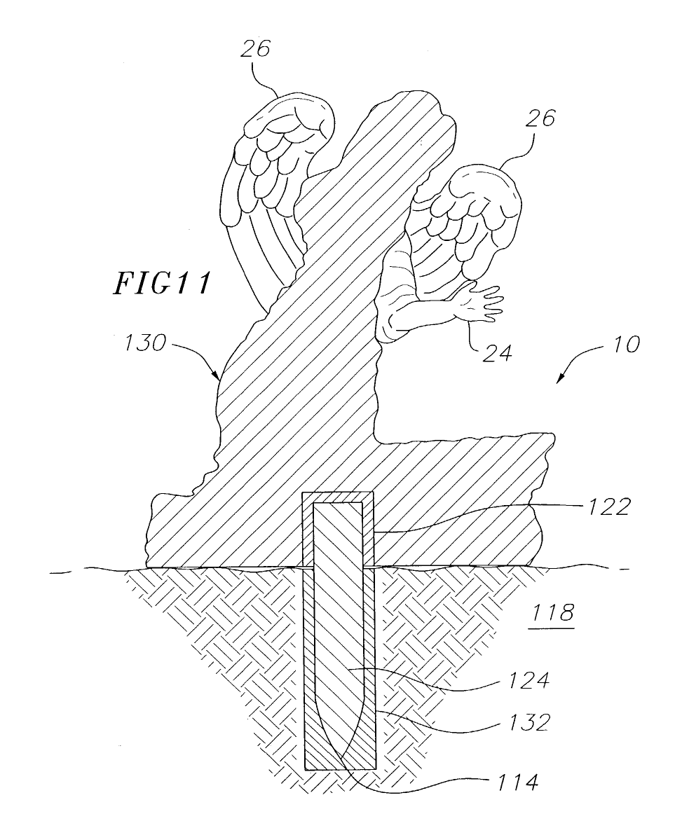

A memorial 130 shown in FIG. 11 is identical with that shown in FIG. 10, except that the stake 124 makes a snug fit into an upwardly opening socket 132 embedded in the ground or other surface 118. The upper end of the stake projects above the surface, and makes a snug fit into the downwardly opening socket 122 embedded in the base of memorial 130.

Of course, the stake shown in FIGS. 7-11 can be of any cross-section, such as circular, square, or the like, and the sockets shaped with a cavity in which the stake makes a snug fit.

I claim:

1. An urn for storing cremated remains of a person or a pet, the urn comprising:
a body in the shape of a protective angel on a support having an outwardly extending shelf adjacent the angel, and on which a representation of the person or pet may rest;
an outwardly opening cavity in the body for receiving the cremated remains; and
a cover secured over the cavity to secure the cremated remains within the body.

2. An urn according to claim 1 in which the angel is seated on a pedestal formed integrally with the body.

3. An urn according to claim 1 or 2 in which the angel is leaning over the shelf.

4. An urn according to claim 1 or 2 in which the angel is looking down at the shelf.

5. An urn according to claim 1 or 2 in which the angel includes outstretched wings opening toward the shelf.

6. An urn according to claim 1 or 2 in which the angel includes an arm extending out over the shelf.

7. An urn according to claim 1 or 2 in which the body includes a base having external grooves to give the base the appearance of being made of stones.

8. An urn according to claim 1 or 2 which includes a recessed panel in part of the body to receive a label with information relative to the person or pet.

9. An urn according to claim 1 or 2 which includes a cover secured to the bottom of the urn to be moveable between an open position and a closed position where the cover fits over the cavity in the body.

10. An urn according to claim 9 in which the cover in the closed position makes a smooth, flat surface with the bottom of the body.

11. An urn according to claim 9 which includes a magnetic closure for holding the cover in the closed position.

12. An urn according to claim 9 which includes a releasable mechanical latch for locking the cover in the closed position.

13. An urn according to claim 9 in which the body includes an indentation adjacent the free edge of the cover to facilitate pulling the cover from the closed to an open position.

14. An urn according to claim 12 in which the free edge of the cover includes an outwardly opening notch to facilitate pulling the cover from a closed to an open position.

15. An urn according to claim 9 which includes a gasket disposed to seal the cavity when the cover is in the closed position.

16. An urn according to claim 9 in which a hinge secures the cover to the bottom of the urn.

17. A memorial for a person or a pet, the memorial comprising:
a body in the shape of a protective angel; and
a support having an outwardly extending shelf adjacent the angel, and on which a representation of the person or pet may rest.

18. A memorial according to claim 17 in which the angel is seated on a pedestal formed integrally with the body.

19. A memorial according to claim 17 or 18 in which the angel is leaning over the shelf.

20. A memorial according to claim 17 or 18 in which the angel is looking down at the shelf.

21. A memorial according to claim 17 or 18 in which the angel includes outstretched wings opening toward the shelf.

22. A memorial according to claim 17 or 18 in which the angel includes an arm extending out over the shelf in a protective pose.

23. A memorial according to claim 17 or 18 in which the body includes a base having external grooves to give the base the appearance of being made of stones.

24. A memorial according to claim 17 or 18 which includes a recessed panel in part of the body to receive a label with information relative to the person or pet.

25. A memorial according to claim 17 or 18 which includes a connection for anchoring the memorial to the ground.

26. A memorial according to claim 25 in which the connection is a downwardly extending stake secured to the memorial.

27. A memorial according to claim 25 in which the connection includes a downwardly opening recess in the body for receiving the upper end of a stake in the ground.

28. A memorial according to claim 27 which includes an inverted socket secured in the recess.

29. A memorial according to claim 25 which includes a downwardly opening socket in the body, an upwardly opening socket adapted to be embedded in the ground, and a stake adapted to fit in the two sockets to secure the memorial to the ground.
